(19) United States
(12) Patent Application Publication
(10) Pub. No.: US 2020/0067792 A1
(43) Pub. Date: Feb. 27, 2020

(54) SYSTEM AND METHOD FOR IN-BAND TELEMETRY TARGET SELECTION

(71) Applicant: ARGELA YAZILIM VE BILISIM TEKNOLOJILERI SAN. VE TIC. A.S., Istanbul (TR)

(72) Inventors: NILGUN AKTAS, ISTANBUL (TR); ISMAIL BAYRAKTAR, ISTANBUL (TR); MAHIR GUNYEL, ISTANBUL (TR); M SERKANT ULUDERYA, ISTANBUL (TR)

(21) Appl. No.: 16/107,978

(22) Filed: Aug. 21, 2018

(51) Int. Cl. H04L 12/24; H04L 12/721; H04L 12/26; H04L 12/715

(52) U.S. Cl. CPC H04L 41/5009; H04L 41/12; H04L 45/38; H04L 45/14; H04L 43/12; H04L 43/0829; H04L 45/64; H04L 43/16

(57) ABSTRACT

A system, method an article of manufacture is described for the implementation in a target selection function that receives (from a probe) one or more key performance indicator (KPI) threshold violations, receives a data network topology and traffic routing information (e.g., from the SDN controller or the routers in a data network), correlates the received KPI threshold violations and the received traffic routing information to determine network switches/routers on which in-band telemetry is to be initiated, and communicates an in-band telemetry request to such determined switches/routers.

### BACKGROUND OF THE INVENTION

### Field of Invention

The present invention relates generally to a system and method in a Software Defined Network (SDN) wherein an intelligent target selection mechanism for in-band Telemetry (INT) is provided with the aid of out-of-band telemetry by using network probes, and more specifically it relates to monitoring for the health of traffic flows directly from the data plane.

### Discussion of Related Art

Software Defined Networking (SDN) currently refers to approaches of networking in which the control plane is decoupled from the data plane of forwarding functions, and assigned to a logically centralized controller, which is the ‘brain’ of the network. The SDN architecture, with its software programmability, provides agile and automated network configuration and traffic management that is vendor neutral and based on open standards. Switches in SDN forward data packets according to instructions they receive from one or more controllers using a standardized protocol such as OpenFlow. A controller configures the packet forwarding behavior of switches by setting packet-processing rules in the form of ‘match-action’ in a so-called ‘flow table’. The match criteria are multi-layer traffic classifiers that inspect specific fields in the packet header (source MAC address, destination MAC address, VLAN ID, source IP address, destination IP address, source port, etc.), and identify the set of packets to which the specified ‘actions’ will be applied. The actions may involve modification of the packet header and/or forwarding through a defined output port. Each packet stream that matches the criteria is called a ‘flow’. If there are no rules defined for a particular packet stream, depending on the table-miss configuration set by the network administrator, the switch receiving that packet stream will either discard it or forward it along the control network to the controller requesting instructions on how to forward them.

The controller is the central control point of an SDN and hence vital in the proper operations of network switches. The controller is directly or indirectly attached to each switch forming a control network in which the controller is at the center and all switches are at the edges. OpenFlow protocol runs bi-directionally between the controller and each switch on a secured or unsecured TCP channel. If the switch is a P4 switch, the controller can directly program the hardware of the switch by sending a P4 program.

One of the key attributes of Software Defined Networks (SDN) is the decoupling of route determination and packet forwarding. Route determination function is performed within the controller. The calculated routes are mapped into so called flow rules, within the controller, which form the set of instructions prepared for each individual network switch, precisely defining where and how to forward the packets of each flow (a traffic stream) passing through that switch. The ‘where’ part defines to which outgoing port of switch the packet must be sent, whereas the ‘how’ part defines what changes must be performed to each packet matching a criteria in the flow table (changes in the header fields, for example). The controller sends the flow rules to each network switch, and updates them as the network map changes. Route determination is attributed to the control plane, i.e., the controller, whereas forwarding is attributed to the data plane, i.e., the switches. As part of the control plane operations, SDN controller derives the network topology map by discovering the connectivity between switches from the data plane using a discovery protocol.

In-band Network Telemetry (“INT”) is a new framework designed particularly for to an SDN (but not exclusively) to allow the collection and reporting of the network state, directly from the data plane, without requiring intervention or work by the control plane. Using the ‘match-action’ paradigm of SDN, network switches can simply augment the packet header that matches a specific criterion, by the action of inserting specific telemetry data into the packet header. Packets contain header fields that are interpreted as “telemetry instructions” by network switches. The INT starts at an ‘INT Source’, which is a trusted entity that creates and inserts the first INT Headers into the packets it sends. INT terminates at an ‘INT Sink’, which is a trusted entity that extracts the INT Headers, and collects the path state contained in the INT Headers. The INT Sink is responsible for removing INT Headers.

The INT header contains two key information (a) INT Instruction—which is the embedded instruction as to which metadata to collect from network switches and (b) INT Metadata—which the telemetry data INT source or any transit switch up to the INT sink inserts into the INT header. The switch that is the INT source of the packet flow receives a match-action criteria to insert an INT header into each packet's header in the form of an INT instruction plus INT metadata, all transit switches along the flow path simply inspect the INT instruction in the header and insert their INT metadata, and the switch (or a host) that is the INT sink removes the INT header and sends all the INT metadata to a monitoring application. The INT scope is between INT Source and INT Sink.

In theory, one may be able to define and collect any information pertaining to a switch using the INT approach. In practice, however, it seems useful to define only a small meaningful set of metadata. Switch ID, ingress port ID, egress port ID, hop latency (internal to the switch), egress port transmission link utilization, buffer occupancy and queue congestion status are the defined key INT metadata in the current specification. The INT specification of P4.org has the detailed description of each metadata. The following are a few key applications of INT:
Path verification: collect switch ID, and ingress and egress port ID metadata along the path of a specific flow to verify the path it traverses.
Path delay verification: collect hop latency in the form of a time stamp per switch in addition to path verification metadata specified above.
Congestion verification: collect at each switch the egress buffer occupancy and egress port utilization metadata in addition to the above.
Buffer-bloat identification: determine all flows that pass through an identified buffer that is in buffer-bloat state.

INT can be initiated simply by the system administrator using a Command Line Interface (CLI) or using a command from the SDN controller, and by an external INT application. The INT are initiated by a set of ‘match-action’ commands, which specify what each switch has to insert as INT metadata into specific packet's header.

There are numerous unaddressed challenges in INT:
1. In-band telemetry generates enormous amounts of data to be processed by an INT sink or the monitoring application. This may delay immediate action in case there is a network failure or major congestion.
2. In-band telemetry information is inserted into the header of each packet in a flow (generally by each switch along the path of the flow) causing the packet header and as a result the packet size to grow substantially as compared to the original packet size. The packet size may actually grow beyond the MTU size forcing fragmentation, which is highly undesirable. For example, if one fragment of an IP packet is dropped, then the entire original packet must be resent, and re-fragmented. Other disadvantages of fragmentation are well reported in prior art.
3. The extra INT packet metadata inserted into each packet causes notable increase in network traffic clogging facilities and switches.
4. In-band telemetry require switches to process packet headers and insert telemetry data, which eats up switch processing and slows down switches.
5. Some switches can perform INT on the fast path (using hardware fabric), while other switches may need to generate a copy or a digest of the original packet and process INT on a slow path. A new packet called a “follow-up packet” containing the execution results of the INT instructions. The follow-up packet is forwarded separately from the original packet. It is possible that a single packet could spawn multiple follow-up packets along the path as it traverses switches—and in turn each of these could spawn more INT processing downstream causing excessive replication.
6. In-band telemetry generates additional control traffic to instruct switches what to measure and where to measure.

In order to overcome the shortcomings listed above, an intelligent target selection mechanism is devised according to this invention to use INT only sparingly, and as intelligently as possible. An out-of-band telemetry mechanism such as network probes are used to monitor Key Performance Indicators (KPIs) at the edges of the network or at key interfaces, and to compare them against KPI thresholds, triggering further drill down under threshold violations using in-band telemetry. Doing so, INT is only used when detailed information about a problem is needed directly from network switches. The intelligent target selection (ITS) mechanism specify:
1. Particular traffic flows to apply INT, as opposed to all flows.
2. Network regions and switches to insert INT metadata, as opposed to the entire network.
3. Specific information to measure (e.g., hop count, or specific queue length on an egress port), as opposed to all metadata.
4. Time to start and stop the INT process for each flow.

To summarize, in-band Network Telemetry (INT) is a way of harvesting information about the packet flows directly from the data plane. Upon a command, a switch inserts a piece of information, known as metadata, in each packet's header on specific flow(s). The INT sink then extracts the metadata from each packet's header and sends it to an external application to analyze and assess the network behavior impacting the packet flow's behavior such as delay and packet loss. The current INT solutions do not have an intelligent target selection mechanism to initiate monitoring of specific flows, for specific time periods, or from specific switches or queues. As a result, extremely large amounts of metadata are almost randomly collected from numerous flows and for long time intervals before pinpointing a problem.

This invention has a system and method to intelligently trigger the in-band telemetry based on specific measurements at network's key interfaces using out-of-band telemetry comprised of various probes and an application that assess the measured data. In an embodiment, Key Performance Indicator (KPI) threshold violations measured by network probes are fed into a new application called ‘target selection function (TSF)’, which correlates these violations, determines where to apply INT, and activates/controls in-band telemetry behavior on the data plane. The TSF basically determines what to measure, where to measure, and how long to measure by (a) correlating various KPI threshold violations, (b) determining flows that are impacted by said violations, and (b) determining switches along the path of the impacted flows in the data plane to activate INT—based on network topology map and traffic routing. TSF then uses an INT driver to send appropriate commands/programs to the switches at the data plane to specify what metadata to measure and to control (start and stop) INT according to INT specification. TSF can use information from multiple probes wherein each probe can be located at a different location or interface.

Embodiments of the present invention are an improvement over prior art systems and methods.

### SUMMARY OF THE INVENTION

In one embodiment, the present invention provides a method as implemented in a target selection function in a data network of a software defined network (SDN), the SDN comprising: (1) a plurality of network switches, each network switch in the plurality of network switches having in-band telemetry capabilities, (2) one or more network probes implemented at a plurality of network interfaces at edges of the data network to measure key performance indicators (KPI), and (3) an SDN controller controlling the data network, the method comprising the steps of: (a) receiving from at least one network probe in the one or more network probes, one or more KPI threshold violations; (b) receiving a data network topology and traffic routing information from the SDN controller; (c) correlating the one or more KPI threshold violations received in (a) and the traffic routing information received in (b); (d) determining a subset of network switches within the plurality of network switches on which in-band telemetry is to be initiated; and (e) communicating an in-band telemetry request to the subset of network switches.

In another embodiment, the present invention provides a method as implemented in a target selection function in an Internet Protocol (IP) network, the IP network comprising: (1) a plurality of network routers, each network routers in the plurality of network routers having in-band telemetry capabilities, and (2) one or more network probes implemented at a plurality of network interfaces at edges of the IP network to measure key performance indicators (KPI), the method comprising the steps of: (a) receiving from at least one network probe in the one or more network probes, one or more KPI threshold violations; (b) receiving a data network topology and traffic routing information from at least one network router in the plurality of routers; (c) correlating the one or more KPI threshold violations received in (a) and the traffic routing information received in (b); (d) determining a subset of network routers within the plurality of network routers on which in-band telemetry is to be initiated; and (e) communicating an in-band telemetry request to the subset of network routers.

In yet another embodiment, the present invention provides an in-band telemetry (INT) controller implemented as an application in a software defined network (SDN), the SDN comprising: (1) a plurality of network switches forming a data network, each network switch in the plurality of network switches having in-band telemetry capabilities, (2) one or more network probes implemented at a plurality of network interfaces at edges of the data network to measure key performance indicators (KPI), and (3) an SDN controller controlling the data network, the INT controller comprising: (a) a target selection function, the target selection function: (1) receiving from at least one network probe in the one or more network probes, one or more KPI threshold violations; (2) receiving a data network topology and traffic routing information from the SDN controller; (3) correlating the one or more KPI threshold violations received in (1) and the traffic routing information received in (2); (4) determining a subset of network switches within the plurality of network switches on which in-band telemetry is to be initiated; and (b) an INT-driver function communicating an in-band telemetry request to the subset of network switches determined in (a)(4).

In another embodiment, the present invention provides an in-band telemetry (INT) controller implemented as an application in an Internet Protocol (IP) network, the IP network comprising: (1) a plurality of network routers, each network routers in the plurality of network routers having in-band telemetry capabilities, and (2) one or more network probes implemented at a plurality of network interfaces at edges of the IP network to measure key performance indicators (KPI), the INT controller comprising: (a) a target selection function, the target selection function: (1) receiving from at least one network probe in the one or more network probes, one or more KPI threshold violations; (2) receiving a data network topology and traffic routing information from at least one network router in the plurality of routers; (3) correlating the one or more KPI threshold violations received in (1) and the traffic routing information received in (2); (4) determining a subset of network routers within the plurality of network routers on which in-band telemetry is to be initiated; and (b) an INT-driver function communicating an in-band telemetry request to the subset of network routers determined in (a)(4).

In yet another embodiment, the present invention provides an article of manufacture comprising non-transitory computer storage medium storing computer readable program code which, when executed by a processor in a single node, implements an in-band telemetry (INT) controller implemented as an application in a software defined network (SDN), the SDN comprising: (1) a plurality of network switches forming a data network, each network switch in the plurality of network switches having in-band telemetry capabilities, (2) one or more network probes implemented at a plurality of network interfaces at edges of the data network to measure key performance indicators (KPI), and (3) an SDN controller controlling the data network, the non-transitory computer storage medium comprising: (a) computer readable program code implementing a target selection function, the target selection function: (1) receiving from at least one network probe in the one or more network probes, one or more KPI threshold violations; (2) receiving a data network topology and traffic routing information from the SDN controller; (3) correlating the one or more KPI threshold violations received in (1) and the traffic routing information received in (2); (4) determining a subset of network switches within the plurality of network switches on which in-band telemetry is to be initiated; and (b) computer readable program code implementing an INT-driver function communicating an in-band telemetry request to the subset of network switches determined in (a)(4).

In another embodiment, the present invention provides an article of manufacture comprising non-transitory computer storage medium storing computer readable program code which, when executed by a processor in a single node, implements an in-band telemetry (INT) controller implemented as an application in an Internet Protocol (IP) network, the IP network comprising: (1) a plurality of network routers, each network routers in the plurality of network routers having in-band telemetry capabilities, and (2) one or more network probes implemented at a plurality of network interfaces at edges of the IP network to measure key performance indicators (KPI), the non-transitory computer storage medium comprising: (a) computer readable program code implementing a target selection function, the target selection function: (1) receiving from at least one network probe in the one or more network probes, one or more KPI threshold violations; (2) receiving a data network topology and traffic routing information from at least one network router in the plurality of routers; (3) correlating the one or more KPI threshold violations received in (1) and the traffic routing information received in (2); (4) determining a subset of network routers within the plurality of network routers on which in-band telemetry is to be initiated; and (b) computer readable program code implementing an INT-driver function communicating an in-band telemetry request to the subset of network routers determined in (a)(4).

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIGS. 1A and 1B illustrate a simple network according to prior art.

FIGS. 2A-2D illustrate the INT packet header according to prior art.

FIG. 3 illustrates an LTE core network monitored with probes according to prior art.

FIG. 4 illustrates a high-level block diagram of the network with the systems of invention.

FIG. 5 illustrates key functions of TSF according to this invention.

FIGS. 6A-6D illustrate various embodiments of the system of invention.

FIG. 7 illustrates a simple messaging diagram showing the method of invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

As used herein, a network device such as a switch, or a controller is a piece of networking equipment, including hardware and software that communicatively interconnects other equipment on the network (e.g., other network devices, end systems). Switches provide multiple layer networking functions (e.g., routing, bridging, VLAN (virtual LAN) switching, Layer 2 switching, Quality of Service, and/or subscriber management), and/or provide support for traffic coming from multiple application services (e.g., data, voice, and video). A network device is generally identified by its media access (MAC) address, Internet protocol (IP) address/subnet, network sockets/ports, and/or upper OSI layer identifiers.

A probe, well known in prior art, is a special type of software running on a computer placed at a specific location within the network to scan traffic passing through it. For example, a probe installed at a port of a router receives a copy of each IP packet passing that port to analyze it. The probe can be configured to scan specific types of packets (such as packets of specific protocol types) and/or at specific time intervals. A probe can proactively generate ping and/or trace-route packets and send them to certain network locations to diagnose problems.

Probes construct Key Performance Indicator (KPIs) and counter values after interpreting packets. Protocol probes interpret only decoded protocol messages such as INAP, TCAP, SIP received from the underlying protocol layer. Probes can send the KPIs and counter values to a special performance-monitoring server (referred as the Monitoring Function) that can receive KPIs from many probes, and process and display the results in graphical or tabular form for the network administrator. KPIs signify packet latency, packet loss, errors, and throughput. The following are the definition of a few exemplary KPIs for IP data traffic:
Retransmission Ratio (RR) (%)=(Total Number of Retransmitted Packets)/(Total Number of Packets Uploaded+Total Number of Packets Downloaded)
Round Trip Average Time (RTT)=(Total Round Trip Time Host Side+Total Round Trip Time Network Side)/(Total Number of Successful IP-Service Access)
Out of Order Packets Ratio (OOPR) (%)=(Total Number Of Out Of Order Packets)/(Total Number of Packets Uploaded+Total Number of Packets Downloaded)

RTT is an important KPI signifying the average time required for a packet to travel from a specific source to a specific destination and back again. RR and OOPR are applicable to TCP traffic only wherein packets are sequence numbered.

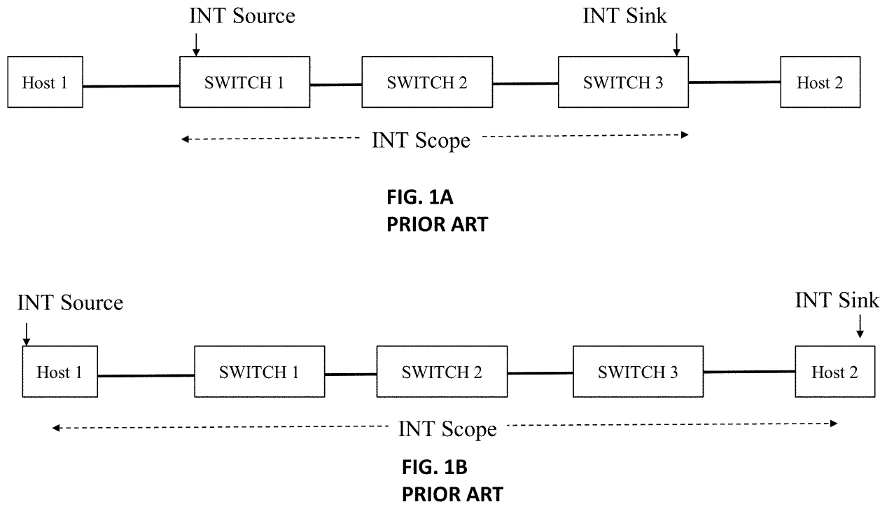

FIGS. 1A and 1B illustrate a simple network segment between Host 1 and Host 2 that is comprised of three switches, labeled Switch 1, 2 and 3. The INT scope is between Switches 1 and 3 in FIG. 1A wherein Switch 1 is the INT Source (where the first metadata is measured) and Switch 3 is the INT Sink (where the last metadata is measured). This scenario is contrasted against an INT Scope that is between Hosts 1 and 2 in FIG. 1B wherein INT Source is Host 1 and INT Sink is Host 2. In both cases, Switches 1, 2 and 3 insert metadata into each IP packet header of the flow along the INT Scope. In the second scenario, Host 2 can piggyback all the metadata it received and send it back in the reverse direction towards Host 1.

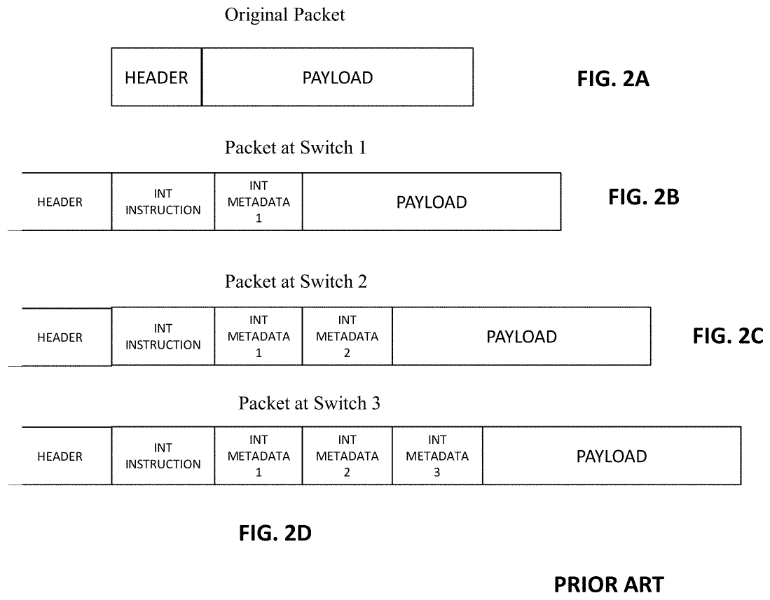

FIGS. 2A-2D illustrate the packet headers at each switch corresponding to FIGS. 1A and 1B. Original packet sent by Host 1 is in FIG. 2A. Switch 1 inserts the INT instruction and the INT metadata of Switch 1 according to FIG. 2B and passes the packet to Switch 2. Switch 2 inserts its INT metadata according to FIG. 2C and passes the packet to Switch 3. Switch 3 inserts the INT metadata for Switch 3 according to FIG. 2D and passes the packet to Host 2. Note that INT instruction is only inserted in Switch 1. Switches 2 and 3 simply inspect this field in the header, and accordingly, add their metadata. The metadata in the packet header therefore form an onion ring.

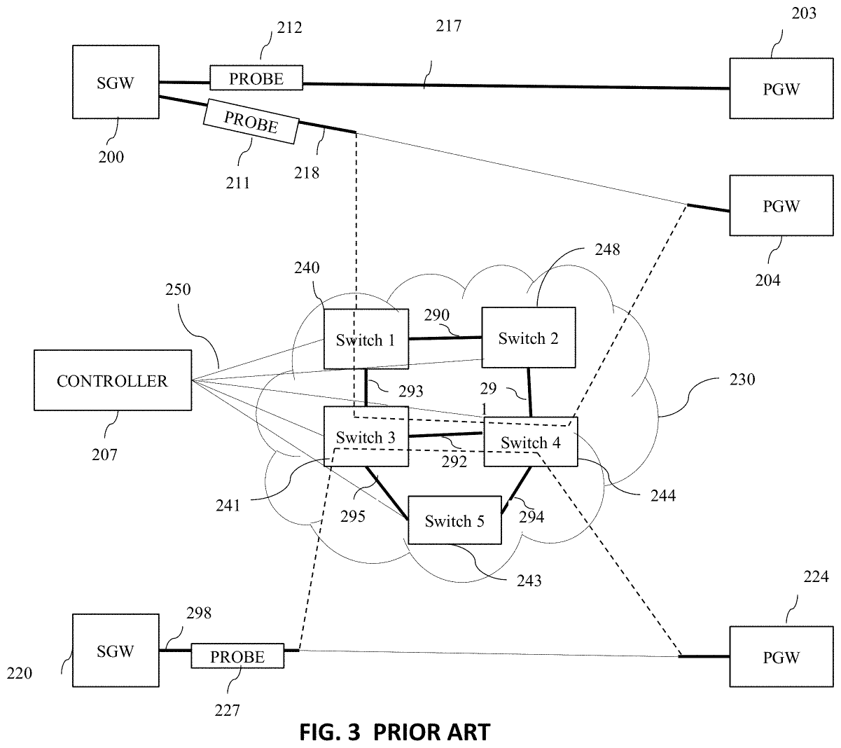

FIG. 3 illustrates a prior art mobile network's LTE core network with two Serving Gateways (SGWs) and three Packet Data Gateways (PGWs). Other core network components such as MME and HSS are not illustrated for simplicity. SGW 200 is associated with PGW 203 and PGW 204 while SGW 220 is associated with PGW 224. Connection 217 between SGW 200 and PGW 203 is a direct facility. Connection 218 between SGW 200 and PGW 204 passes through routed network 230 via Switch 240, 241 and 244. Similarly, Connection 298 between SGW 220 and PGW 224 passes through the same network cloud via Switches 241 and 244. Note that network cloud 230 is an SDN with Controller 207, wherein the controller is attached to each switch with control network 250. The Switches 240, 241, 243, 244 and 248 form the data plane of SDN 230. Facilities 290, 291, 292, 293, 294 and 295 interconnect the switches.

Three probes are used to monitor the performance of the core network: Probes 212 and 211 at the egress port of SGW 200 towards PGW 203 and 204, respectively, wherein Probe 212 is on the port attached to facility 217 and Probe 211 on the port attached to facility 218. Probe 227 is at the egress side of SGW 220 towards PGW 224 on the port attached to facility 298. Note that the KPIs and counter values obtained from Probes 211 and 227 are aggregate measurements of SDN 230 because packets that traverse these probes traverse several switches interior to the SDN. For example, if Switch 4 has a buffer-bloat at its port towards Switch 3, RTT KPIs measured at both Probes 211 and 227 will both have a threshold violation. However, the performance monitoring system would not know the reason unless the network topology is mapped out and In-band Telemetry is activated on these paths to collect data from each switch on the data path. In summary, probes monitor network conditions at a macro level (aggregate), wherein INT monitors network conditions at a micro level (per switch, per port, per buffer). An overall system (with probes and INT) should pinpoint the problem source as Switch 4.

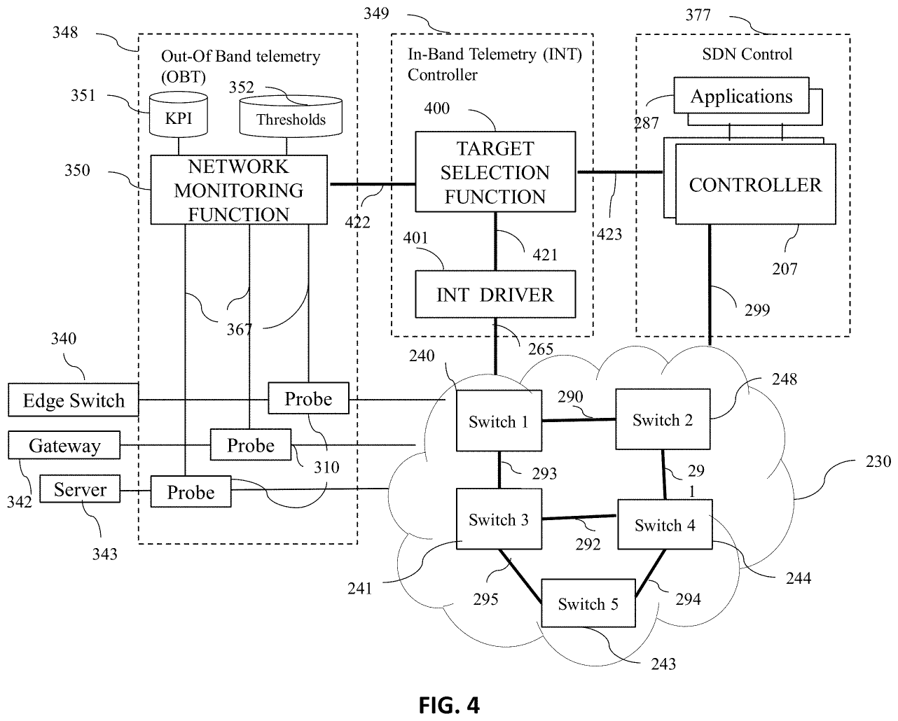

FIG. 4 illustrates the Target Selection Function (TSF) 400, a key component of the system of invention over SDN cloud 230. Probes 310 are used for out of band telemetry (OBT) of Edge Switch 340, Gateway (SGW or PGW) 342 and Server 343. Probes 310 feed KPIs and counter values to Network Monitoring Function 350 via links 367. SDN control plane 377 is also illustrated with one or more controllers 207 and one or more control applications 287.
TSF 400 receives KPI violations from Network Monitoring Function 350 on interface 422, which is a simple API such as the REST API.
TSF 400 receives routing tables and network map from Controller 207 on interface 423, which is the ‘Northbound’ API provided by the Controller. This is the same API that all controller Applications 287 uses.
TSF 400 sends INT requests to INT Driver 401 based on information it receives from OBT 348. INT Driver 401, in turn, configures Switches 240, 241, 243, 244 and 248 for INT metadata gathering and packet header insertion. Interface 265 between INT Driver 401 and Switches is either OpenFlow or P4Runtime or another type of configuration protocol. Controller 207 also communicates with Switches via OpenFlow or P4Runtime or another configuration protocol that is the same as Interface 265 or different.

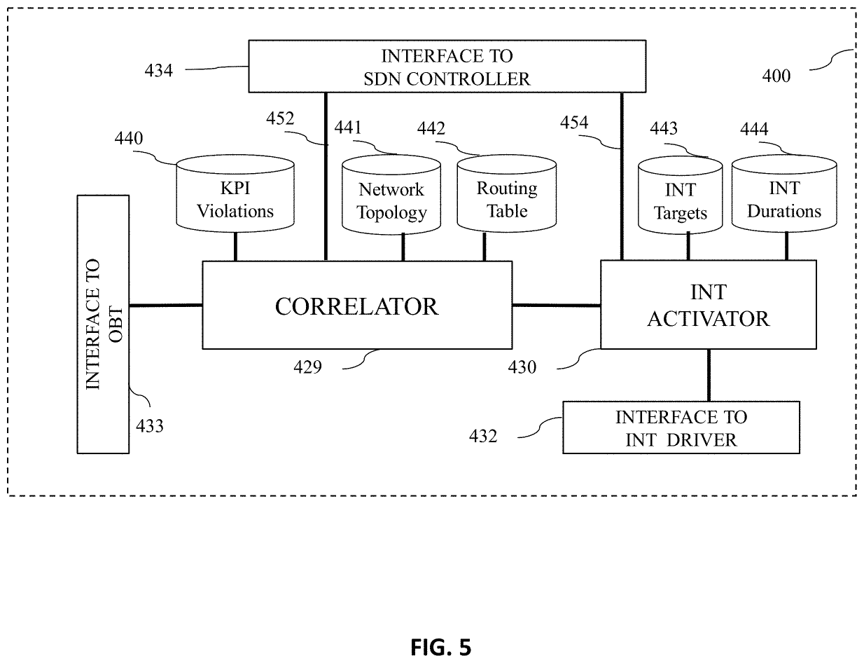

Functionality of Target Selection Function 400 is further detailed in FIG. 5. It has two key functions: Correlator 429 and INT Activator 430. Correlator 429 is where all KPI violations are first received from OBT Interface 433. These KPI violations are first stored in Database 440. Correlator 429 acquires network topology map using interface 452 from Controller 207 and stores the most up to data topology in Database 441. Controller 207 may ‘push’ network topology to Correlator 429 when there are changes or Controller 207 may ‘publish’ this information and the Correlator 429 may ‘subscribe’ to it if a pub-sub model is used. Alternatively, Correlator 429 may pull the data from Controller 207 periodically. Network Routing Database 442 stores the network routing table obtained from Controller 207. Correlator 429 may receive a constant feed of changes (push) in the routing tables from Controller 207, or alternatively it may pull the data from Controller 207 periodically, or alternatively it may subscribe to published routing tables. Correlator 429 simply correlates KPI violations against network topology and routing information. For example, when Probes 211 and 227 both start reporting RTT violations (see FIG. 3), Correlator 429 first determines the actual route/path of the impacted traffic using both the network topology and routing information. Both routes traverse a common topology route segment that passes Switches 241 and 244, in which case Correlator 429 makes a determination to initiate INT only on these two switches first. Correlator 429 feeds these INT Targets (switches 241 and 244 in this scenario) to INT Activator 430, which stores this information in INT Targets Database 443. It also stores the start and stop times of each INT monitoring in INT Durations Database 444.

INT Activator 430 is responsible for activating INT on the selected network segments by communicating with INT Driver 432. For example, it sends the IP numbers of Switches 241 and 244 to INT Driver along with the requested metadata to monitor, which is switch delay and queue length at the egress port of both switches. INT Activator 430 formulates the INT Instruction that goes to Switch 241 wherein the INT Source is Switch 241 and INT Sink is Switch 244.

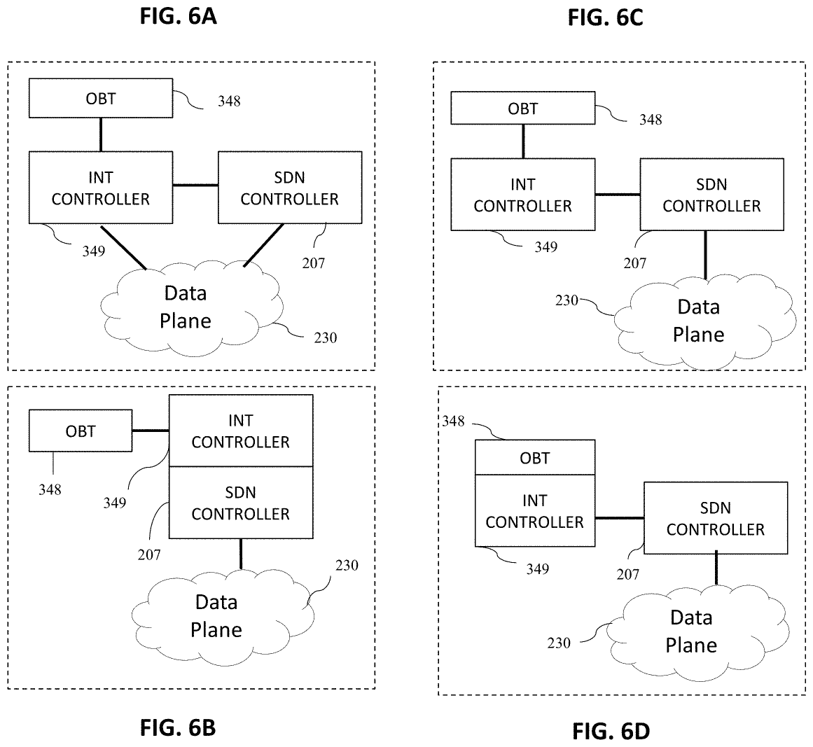

FIGS. 6A-6D depict various possible embodiments INT Controller 349 depending on how it is implemented. In FIG. 6A OBT, INT Controller and SDN Controller are completely separate systems. INT Controller interfaces with both SDN Controller and OBT, but it controls the network through its own INT Driver. In this scenario, both SDN Controller and INT Driver have rights to configure the switches. In FIG. 6B INT Controller and SDN Controller are within the same system. INT Controller interfaces with OBT only, and it controls the network through Controller's interface to the Data Plane. In this embodiment, TSF is an integral part of the Controller and obviously the INT Driver is not needed. FIG. 6C OBT, INT Controller and SDN Controller are separate systems. However, INT Controller does not interface with the network directly. Instead, it sends INT requests to the Controller, which then implements it on the Data Plane. FIG. 6D is another variant wherein OBT and INT Controller are the same system. However, INT Controller does not interface with the network directly. Instead, it sends INT requests to the Controller, which then implements it on the Data Plane. Embodiments in FIGS. 6B, 6C and 6D do not need a separate INT Driver.

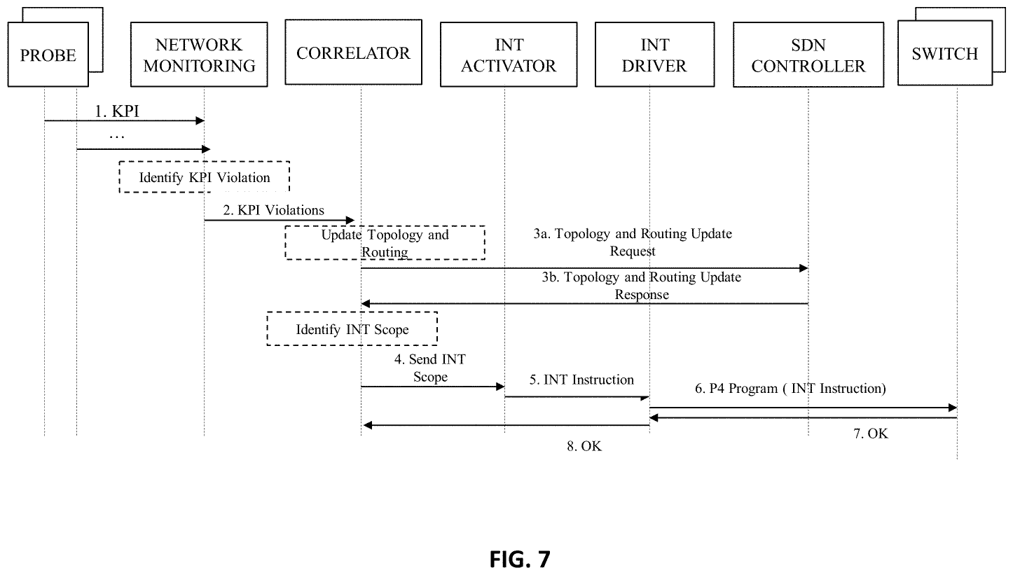

FIG. 7 illustrates a simple messaging flow that shows how target selection sub-function work in a coupled way with SDN controller and network probes. At step 1, Probes send measured KPIs to Network Monitoring Function according to prior art, which in turn detects KPI violations by comparing the measurements against configured thresholds. At step 2, Network Monitoring Function sends KPI violations to Correlator sub-function of INT Controller 349. In turn, Correlator obtains a most up to date topology and routing information from SDN Controller in steps 3a and 3b. Having this information in hand, Correlator determines where to trigger In-band Telemetry measurements (viz. INT Scope). In Step 4, Correlator sends INT Scope to INT Activator, which in turn formulates the INT Instruction accordingly, and sends it to INT Driver in Step 5. In Step 6, INT Driver communicates the new INT Instruction to network switches directly (or via SDN Controller). The network switches respond with an ‘OK’ in Step 7. The INT Driver communicates ‘OK’ to the Correlator, which initiates the INT action. This message sequence is designed to illustrate the relationship between various components of this invention. However, the steps may be executed in a different order, and/or various embodiments may implement the illustrated functions in an integrated or further decomposed way. All these variations are assumed as covered by this invention. Furthermore, an embodiment may implement the TSF without the Correlator sub-function. In such an embodiment, each KPI violation is treated as a separate trigger for an INT Scope.

The above-described features are illustrated in the Figures for an LTE core network for simplicity. However, same functions can be implemented in an SDN-based 5G mobile core network, or another type of SDN network that is not a mobile network (a WAN or a data center network, for example). Same functions can even be implemented in an IP network that is not an SDN, in which case the INT Driver of the INT Controller supports a configuration API of network switches and the needed routing information is obtained directly from switches. In the most primitive case, the INT Driver may even be a Command Line Interface (CLI). Furthermore, the probes may or may not feed the KPIs to a separate Network Monitoring Function. Instead, each probe can determine a KPI violation from its own KPI measurements, and directly report the violation to INT Controller. Such variations are within the scope of this invention. Furthermore, the application that receives and assesses the INT metadata and determines the actual cause of a network problem is left out of scope as it is specified already in prior art.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

In one embodiment, the present invention provides an article of manufacture comprising non-transitory computer storage medium storing computer readable program code which, when executed by a processor in a single node, implements an in-band telemetry (INT) controller implemented as an application in a software defined network (SDN), the SDN comprising: (1) a plurality of network switches forming a data network, each network switch in the plurality of network switches having in-band telemetry capabilities, (2) one or more network probes implemented at a plurality of network interfaces at edges of the data network to measure key performance indicators (KPI), and (3) an SDN controller controlling the data network, the non-transitory computer storage medium comprising: (a) computer readable program code implementing a target selection function, the target selection function: (1) receiving from at least one network probe in the one or more network probes, one or more KPI threshold violations; (2) receiving a data network topology and traffic routing information from the SDN controller; (3) correlating the one or more KPI threshold violations received in (1) and the traffic routing information received in (2); (4) determining a subset of network switches within the plurality of network switches on which in-band telemetry is to be initiated; and (b) computer readable program code implementing an INT-driver function communicating an in-band telemetry request to the subset of network switches determined in (a)(4).

In another embodiment, the present invention provides an article of manufacture comprising non-transitory computer storage medium storing computer readable program code which, when executed by a processor in a single node, implements an in-band telemetry (INT) controller implemented as implemented in a target selection function in an Internet Protocol (IP) network, the IP network comprising: (1) a plurality of network routers, each network routers in the plurality of network routers having in-band telemetry capabilities, and (2) one or more network probes implemented at a plurality of network interfaces at edges of the IP network to measure key performance indicators (KPI), the non-transitory computer storage medium comprising: (a) computer readable program code implementing a target selection function, the target selection function: (1) receiving from at least one network probe in the one or more network probes, one or more KPI threshold violations; (2) receiving a data network topology and traffic routing information from at least one network router in the plurality of routers; (3) correlating the one or more KPI threshold violations received in (1) and the traffic routing information received in (2); (4) determining a subset of network routers within the plurality of network routers on which in-band telemetry is to be initiated; and (b) computer readable program code implementing an INT-driver function communicating an in-band telemetry request to the subset of network routers determined in (a)(4).

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media).

Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

According to this invention a system and method are described wherein Key Performance Indicator (KPI) threshold violations are measured by network probes and fed into INT Controller, the system of invention, which contains an application called ‘target selection function (TSF)’ which determines where to apply In-band Telemetry intelligently and activates/controls in-band telemetry behavior on the data plane. The INT Controller determines what to measure, where to measure, and how long to measure by determining flows that are impacted by said KPI violations and determining on which switches along the path of the impacted flows in the data plane to activate INT—based on network topology map and traffic routing. The method specifies what metadata to measure and to control (start and stop) according to INT specification. INT Controller can use information from multiple probes wherein each probe can be located at a different network location or interface.

1. A method as implemented in a target selection function in a data network of a software defined network (SDN),
the SDN comprising: (1) a plurality of network switches, each network switch in the plurality of network switches having in-band telemetry capabilities, (2) one or more network probes implemented at a plurality of network interfaces at edges of the data network to measure key performance indicators (KPI), and (3) an SDN controller controlling the data network,
the method comprising the steps of:
(a) receiving from at least one network probe in the one or more network probes, one or more KPI threshold violations;
(b) receiving a data network topology and traffic routing information from the SDN controller;
(c) correlating the one or more KPI threshold violations received in (a) and the traffic routing information received in (b);
(d) determining a subset of network switches within the plurality of network switches on which in-band telemetry is to be initiated; and
(e) communicating an in-band telemetry request to the subset of network switches.

2. The method of claim 1, wherein the communicating step in (e) is performed indirectly by the target selection function requesting the SDN controller to communicate the in-band telemetry request with the subset of network switches.

3. The method of claim 1, wherein the communicating step in (e) is performed directly by the target selection function communicating with the subset of network switches and activating in-band telemetry in the subset of network switches.

4. The method of claim 1, wherein the KPI indicators are any of, or a combination of, the following: retransmission ratio (RR) (%)=(total number of retransmitted packets)/(total number of packets uploaded+total number of packets downloaded), round trip average time (RTT)=(total round trip time host side+total round trip time network side)/(total number of successful IP-service access), or out-of-order packets ratio (OOPR) (%)=(total number of out of order packets)/(total number of packets uploaded+total number of packets downloaded).

5. A method as implemented in a target selection function in an Internet Protocol (IP) network,
the IP network comprising: (1) a plurality of network routers, each network routers in the plurality of network routers having in-band telemetry capabilities, and (2) one or more network probes implemented at a plurality of network interfaces at edges of the IP network to measure key performance indicators (KPI),
the method comprising the steps of:
(a) receiving from at least one network probe in the one or more network probes, one or more KPI threshold violations;
(b) receiving a data network topology and traffic routing information from at least one network router in the plurality of routers;
(c) correlating the one or more KPI threshold violations received in (a) and the traffic routing information received in (b);
(d) determining a subset of network routers within the plurality of network routers on which in-band telemetry is to be initiated; and
(e) communicating an in-band telemetry request to the subset of network routers.

6. The method of claim 5, wherein the target selection function interfaces with a network monitoring function associated with each of the one or more probes.

7. The method of claim 5, wherein the KPI indicators are any of, or a combination of, the following: retransmission ratio (RR) (%)=(total number of retransmitted packets)/(total number of packets uploaded+total number of packets downloaded), round trip average time (RTT)=(total round trip time host side+total round trip time network side)/(total number of successful IP-service access), or out-of-order packets ratio (OOPR) (%)=(total number of out of order packets)/(total number of packets uploaded+total number of packets downloaded).

8. An in-band telemetry (INT) controller implemented as an application in a software defined network (SDN),
the SDN comprising: (1) a plurality of network switches forming a data network, each network switch in the plurality of network switches having in-band telemetry capabilities, (2) one or more network probes implemented at a plurality of network interfaces at edges of the data network to measure key performance indicators (KPI), and (3) an SDN controller controlling the data network,
the INT controller comprising:
(a) a target selection function, the target selection function: (1) receiving from at least one network probe in the one or more network probes, one or more KPI threshold violations; (2) receiving a data network topology and traffic routing information from the SDN controller; (3) correlating the one or more KPI threshold violations received in (1) and the traffic routing information received in (2); (4) determining a subset of network switches within the plurality of network switches on which in-band telemetry is to be initiated; and
(b) an INT-driver function communicating an in-band telemetry request to the subset of network switches determined in (a)(4).

9. The INT controller of claim 8, wherein the communicating in (b) is performed indirectly by the target selection function requesting the SDN controller to communicate the in-band telemetry request with the subset of network switches.

10. The INT controller of claim 8, wherein the communicating in (b) is performed directly by the target selection function communicating with the subset of network switches and activating in-band telemetry in the subset of network switches.

11. The INT controller of claim 8, wherein the target selection function interfaces with a network monitoring function associated with each of the one or more probes.

12. An in-band telemetry (INT) controller implemented as an application in an Internet Protocol (IP) network,
the IP network comprising: (1) a plurality of network routers, each network routers in the plurality of network routers having in-band telemetry capabilities, and (2) one or more network probes implemented at a plurality of network interfaces at edges of the IP network to measure key performance indicators (KPI),
the INT controller comprising:
(a) a target selection function, the target selection function: (1) receiving from at least one network probe in the one or more network probes, one or more KPI threshold violations; (2) receiving a data network topology and traffic routing information from at least one network router in the plurality of routers; (3) correlating the one or more KPI threshold violations received in (1) and the traffic routing information received in (2); (4) determining a subset of network routers within the plurality of network routers on which in-band telemetry is to be initiated; and
(b) an INT-driver function communicating an in-band telemetry request to the subset of network routers determined in (a)(4).

13. The INT controller of claim 12, wherein the target selection function interfaces with a network monitoring function associated with each of the one or more probes.

14. The INT controller of claim 13, wherein the KPI indicators are any of, or a combination of, the following: retransmission ratio (RR) (%)=(total number of retransmitted packets)/(total number of packets uploaded+total number of packets downloaded), round trip average time (RTT)=(total round trip time host side+total round trip time network side)/(total number of successful IP-service access), or out-of-order packets ratio (OOPR) (%)=(total number of out of order packets)/(total number of packets uploaded+total number of packets downloaded).

15. An article of manufacture comprising non-transitory computer storage medium storing computer readable program code which, when executed by a processor in a single node, implements an in-band telemetry (INT) controller implemented as an application in a software defined network (SDN), the SDN comprising: (1) a plurality of network switches forming a data network, each network switch in the plurality of network switches having in-band telemetry capabilities, (2) one or more network probes implemented at a plurality of network interfaces at edges of the data network to measure key performance indicators (KPI), and (3) an SDN controller controlling the data network, the non-transitory computer storage medium comprising:
(a) computer readable program code implementing a target selection function, the target selection function: (1) receiving from at least one network probe in the one or more network probes, one or more KPI threshold violations; (2) receiving a data network topology and traffic routing information from the SDN controller; (3) correlating the one or more KPI threshold violations received in (1) and the traffic routing information received in (2); (4) determining a subset of network switches within the plurality of network switches on which in-band telemetry is to be initiated; and
(b) computer readable program code implementing an INT-driver function communicating an in-band telemetry request to the subset of network switches determined in (a)(4).

16. The article of manufacture of claim 15, wherein the communicating in (b) is performed indirectly by the target selection function requesting the SDN controller to communicate the in-band telemetry request with the subset of network switches.

17. The article of manufacture of claim 15, wherein the communicating in (b) is performed directly by the target selection function communicating with the subset of network switches and activating in-band telemetry in the subset of network switches.

18. The article of manufacture of claim 15, wherein the target selection function interfaces with a network monitoring function associated with each of the one or more probes.

19. An article of manufacture comprising non-transitory computer storage medium storing computer readable program code which, when executed by a processor in a single node, implements an in-band telemetry (INT) controller implemented as an application in an Internet Protocol (IP) network, the IP network comprising: (1) a plurality of network routers, each network routers in the plurality of network routers having in-band telemetry capabilities, and (2) one or more network probes implemented at a plurality of network interfaces at edges of the IP network to measure key performance indicators (KPI), the non-transitory computer storage medium comprising:
(a) computer readable program code implementing a target selection function, the target selection function: (1) receiving from at least one network probe in the one or more network probes, one or more KPI threshold violations; (2) receiving a data network topology and traffic routing information from at least one network router in the plurality of routers; (3) correlating the one or more KPI threshold violations received in (1) and the traffic routing information received in (2); (4) determining a subset of network routers within the plurality of network routers on which in-band telemetry is to be initiated; and
(b) computer readable program code implementing an INT-driver function communicating an in-band telemetry request to the subset of network routers determined in (a)(4).

20. The article of manufacture of claim 19, wherein the target selection function interfaces with a network monitoring function associated with each of the one or more probes.

21. The article of manufacture of claim 19, wherein the KPI indicators are any of, or a combination of, the following: retransmission ratio (RR) (%)=(total number of retransmitted packets)/(total number of packets uploaded+total number of packets downloaded), round trip average time (RTT)=(total round trip time host side+total round trip time network side)/(total number of successful IP-service access), or out-of-order packets ratio (OOPR) (%)=(total number of out of order packets)/(total number of packets uploaded+total number of packets downloaded).
